(19) United States
(12) Patent Application Publication
(10) Pub. No.: US 2006/0063083 A1
(43) Pub. Date: Mar. 23, 2006

(54) Toner composition

(75) Inventors: Sang-deok Kim, Seoul (KR); Duck-hee Lee, Seoul (KR); Seok-hoon Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/229,499

(22) Filed: Sep. 20, 2005

(30) Foreign Application Priority Data
Sep. 20, 2004 (KR) 2004-74928

(51) Int. Cl. G03G 9/08

(52) U.S. Cl. 430/108.6; 430/108.7

(57) ABSTRACT

A toner composition includes toner particles containing a coloring agent, a binder, a charge control agent, a release agent, and an external additive, wherein the external additive includes a silica, a calcium-based titanium oxide and a cerium oxide. In the toner composition, by which the image density is maintained stably, the fog phenomenon does not occur, a feeding property is very effective, and the filming phenomenon does not occur.

### CROSS-REFERENCE TO RELATED APPLICATIONS

This application claims benefit under 35 U.S.C. § 119 from Korean Patent Application No. 2004-74928 filed on Sep. 20, 2004, the entire content of which is incorporated herein by reference.

### BACKGROUND OF THE INVENTION

1. Field of the Invention

The present invention relates to a toner composition. More particularly, the present invention relates to a toner composition comprising an external additive having specific components and their ratios so that in a developer of an electrophotographic imaging apparatus, the charged quantity and distribution of the toner may be maintained stably, the background phenomenon may be prevented, and high quality images may be obtained.

2. Description of the Related Art

Recently, an electrophotographic imaging apparatus including a laser printer, a facsimile, a copying machine, etc., through which high quality images may be obtained in high speed, has been generally used. Such an electrophotographic imaging apparatus may be divided into dry-type and wet-type depending on a developer toner. The present invention relates to a dry toner composition that is used in a dry-type electrophotograhphic imaging apparatus.

FIG. 1 schematically illustrates an example of a known dry-type electrophotographic imaging apparatus, which is a non-contacting developing type. Referring to FIG. 1, a photo-conductor 100 is charged by a charging apparatus 600, and then a latent image is formed on the photo-conductor by exposing an image to light through a laser-scanning unit 900. A toner 400 is fed to a developing roller 200 by a feeding roller 300. The toner fed to the developing roller 200 is controlled to form a uniform and thin thickness by a toner layer-control apparatus 500 while the toner is charged using friction with the developing roller 200 and the toner layer-control apparatus 500. In this process, the M/A and Q/M of the toner migrating to the developing area are controlled. The M/A refers to the toner weight per unit area, measured on the developing roller after being passed through the toner layer-control apparatus. The Q/M refers to the charged quantity of the toner (μC/g) per unit weight, measured on the developing roller after being passed through the toner layer-control apparatus. After the toner is passed through the toner layer-control apparatus 500, it is developed on the electrostatic latent image formed on the photo-conductor 100, and the developed toner is transferred to a recording medium by a transferring roller (not shown), and then fused by a fusing apparatus (not shown). After being transferred, the toner remaining on the photo-conductor 100 is cleaned by a cleaning blade 700 and stored in the residual toner collecting bin 800. Then, the processes are repeated again from the charging process to form an image.

A dry toner is generally formed by combining a coloring agent, a binder, a charge control agent and a release agent. The dry toner may further comprise additives, depending on the function to be required for the toner. The additives are divided into an internal additive added into the inside of a toner particle, and an external additive added on a surface of the toner particle. Particularly, a toner is a particulate having the size of a few μm or so that forms a printed image on a recording medium, and its charge property and mobility property are generally the most important factors to control the quality of a printed image. Accordingly, various compounds may be added to a toner composition as an external additive to impart mobility, charge stability, a cleaning property, and the like, to the toner.

Meanwhile, a non-contacting non-magnetic one-component developing type has an advantage of ensuring printed quality with high resolution since downsizing for the system is possible, correspondence with color is easy, and the gradation property is highly effective. However, for the non-contacting non-magnetic one-component developing type, it is required that a toner maintain a constant charged quantity and a uniform charge distribution, even after long-term repeated printing, as well as the initial printing, to maintain a stable developing property and prevent fogging and scattering.

To impart a uniform charging property to a toner, the toner is required to form a thin toner layer on a developing roller. However, when the toner layer is too thin, it deteriorates easily since the toner is seriously stressed. Further, when a thin toner layer is formed on a developing roller, a developing efficiency is drastically decreased due to a drastic rise of toner charges, thus decreasing the image density. When the toner charges are decreased to improve the developing efficiency, contamination by an increase in fogs (or background) and toner scattering may arise.

### SUMMARY OF THE INVENTION

Accordingly, in an aspect of the present invention, a toner composition comprises an external additive having a specific component ratio so that the charged quantity and distribution of the toner may be maintained stably in spite of environmental changes and time-passing changes due to a long-term image printing, and thus, the filming phenomenon and fogging may be prevented, and improved quality images may be obtained.

The above aspect of the present invention is substantially realized by providing a toner composition comprising toner particles that include a coloring agent, a binder, a charge control agent and a release agent, and an external additive, wherein the external additive contains a silica, a calcium-based titanium oxide and a cerium oxide.

The quantity of the silica in the external additive is 0.1% by weight to 8.0% by weight based on 100% by weight of the toner particles.

The quantity of the calcium-based titanium oxide is 0.1% by weight to 3.0% by weight based on 100% by weight of the toner particles.

The quantity of the cerium oxide is 0.1% by weight to 4.0% by weight based on 100% by weight of the toner particles.

Herein, the silica consists of a micro particle silica having a primary particle within a range of 5 nm to 20 nm, the amount of which is 0.1% by weight to 4.0% by weight based on 100% by weight of the toner particles, and a macro particle silica having a primary particle within a range of 30 nm to 200 nm, the amount of which is 0.1% by weight to 4.0% by weight based on 100% by weight of the toner particles.

The calcium-based titanium oxide comprises a primary particle within a range of 500 nm to 1000 nm.

The cerium oxide comprises a primary particle within a range of 1000 nm to 1500 nm.

The silica may be negatively-charged.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing of which:

FIG. 1 is a schematic diagram illustrating a known electrophotographic imaging apparatus.

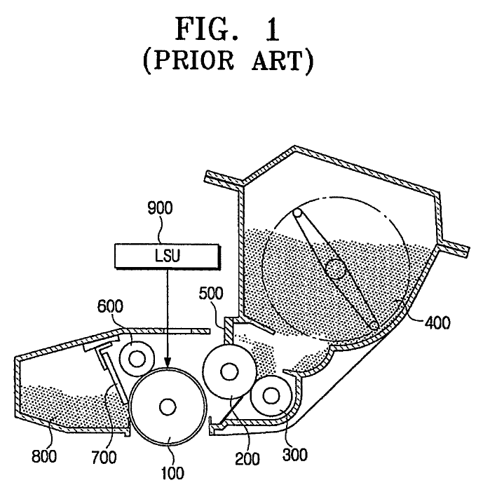

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figure. In the following description, a detailed description of known functions and configurations incorporated herein has been omitted for conciseness and clarity.

A toner composition according to an embodiment of the present invention comprises toner particles that include a coloring agent, a binder, a charge control agent and a release agent, and an external additive.

A coloring agent may includes a dye-based coloring agent and/or a pigment-based coloring agent. Although any known coloring agent for a toner may be used, the pigment-based coloring agent, which is very effective in terms of heat stability and light resistance, in particular, may be used.

The pigment-based coloring agent that may be used in the toner composition according to an embodiment of the present invention includes an organic color pigment, such as an azo-based pigment, a phthalocyanin-based pigment, a basic dye-based pigment, a quinactridone-based pigment, a dioxazine-based pigment and a condensation azo-based pigment; an inorganic color pigment, such as chromates, ferrocyanides, oxides, sulfate selenides, sulfates, silicates, carbonates, phosphates and metal powders; and an inorganic black pigment such as a carbon black. Of these, a single coloring agent may be used, or more than two pigments may be used in mixtures. However, the coloring agent, which may be used in the toner composition of an embodiment of the present invention, is not limited to these.

The quantity of a coloring agent generally contained in a toner composition is within a range of 1% by weight to 10% by weight, based on 100% by weight of the total toner particles.

The binder resin that may be used in the toner composition according to an embodiment of the present invention includes a homopolymer of a styrene such as a polystyrene and a polyvinyltoluene, and its derivative, a styrene copolymer such as a styrene-acrylic copolymer, a polyethylene, a polypropylene, a vinyl chloride-based resin, a polyacrylate, a polymethacrylate, a polyester, a polyacrylonitrile, a melamine resin, an epoxy resin, or the like. Of these, a binder resin may be used, or more than two binder resins may be used in mixtures. However, the binder resin, which may be used in the toner composition of an embodiment of the present invention, is not limited to these.

The quantity of a binder resin generally contained in a toner composition is within a range of 80% to 98% by weight, based on 100% by weight of the total toner particles.

A charge control agent is a material which is added to control charges charged to toner particles. The type of the charge control agent varies depending on whether the charge of toner particles is positive (+) or negative (−).

The negative charge control agent includes an azo-based pigment that includes chrome, a salicylic acid compound containing metal such as chrome, iron, zinc, or the like. The positive charge control agent includes a nigrocine, a quaternary ammonium salt, a triphenylmethane derivative, or the like.

The commercially available charge control agent includes NIGROCINE NO1 (manufactured by ORIENT CHEMICAL COMPANY), NIGROCINE EX (manufactured by ORIENT CHEMICAL COMPANY), AIZEN SPILON BLACK TRH (manufactured by HODOKAYA CHEMICAL COMPANY), T-77 (manufactured by HODOKAYA CHEMICAL COMPANY), BONTRON S-34 (manufactured by ORIENT CHEMICAL COMPANY) and BONTRON E-84 (manufactured by ORIENT CHEMICAL COMPANY), and the like.

The quantity of a charge control agent contained in a toner composition is generally within a range of about 0.1% by weight to about 10% by weight, based on 100% by weight of the total toner particles.

A release agent added to a toner prevents toner offset by improving release properties between a roller and a toner when a toner image is transferred to a recording medium and fused thereon, and prevents the recording medium from sticking to the roller by becoming entangled with it.

The release agent includes low molecular weight polyolefines, silicons having a softening point by heating, fatty acid amides and waxes, and the like. A commercially available wax may be usually used.

A wax that may be used as a release agent in the toner composition according to an embodiment of the present invention includes a natural plant wax, including a carnauba wax and a bay-berry wax; a natural animal wax, including a bees wax, a shellac wax and a spermacetti wax; a mineral wax, including a montanic wax, an ozokerite wax and a ceresin wax; a petroleum wax, including a paraffin wax and a microcrystalline wax; and a synthetic wax, including a polyethylene wax, a polypropylene wax, an acrylate wax, a fatty acid amide wax, a silicon wax, a polytetrafluoroethylene wax, and the like. Of these, any wax may be used alone, or in mixtures of two or more. However, the wax that may be used in the present invention is not limited to these. The quantity of a wax is generally within a range of about 1% by weight to about 10% by weight, based on 100% by weight of the total toner particles.

The toner composition according to an embodiment of the present invention comprises, in addition to the basic components constituting the toner particles, an external additive in a predetermined weight ratio of the external additive with respect to the weight of the total toner particles to maintain a charge quantity and a charge distribution of the toner, to suppress the occurrence of filming and fogging, and to maintain a constant developing property. The external additive contained in the toner composition according to an embodiment of the present invention contains a silica, a calcium-based titanium oxide and a cerium oxide in predetermined ratios.

The quantity of a silica contained in the external additive according to an embodiment of the present invention is within a range of 0.1% by weight to 8.0% by weight, based on 100% by weight of the total toner particles.

A silica is usually used as a dessicant; however, its role varies depending on its particle size. The silica, when the size of its primary particle is approximately above 30 nm, is referred to as a macro particle silica, and the silica, when the size of its primary particle is approximately less than 30 nm, is referred to as a micro particle silica.

According to an embodiment of the present invention, the “primary particle” refers to a unit particle of a compound that is neither polymerized nor bound.

The micro particle silica is primarily added to improve mobility of the toner particles, and the macro particle silica is added to impart chargeability to the toner particles. The silica contained in the external additive according to an embodiment of the present invention may comprise a predetermined ratio of a micro particle silica and a macro particle silica. The quantity of the micro particle silica having a primary particle size within a range of about 5 nm to about 20 nm is generally within a range of about 0.1% by weight to about 4.0% by weight, and the quantity of the macro particle silica having a primary particle size within a range of about 30 nm to about 200 nm is generally within a range of about 0.1% by weight to about 4.0% by weight.

The primary particle size of the micro particle silica and the macro particle silica contained in the external additive of the toner composition is determined with respect to the compatibility with the toner particles and the sizes of the toner particles themselves.

When the quantity of the total silicas is less than about 0.1% by weight, they do not contribute significantly to mobility and chargeability, as is desired with the addition of an external additive. When the quantity of the total silicas is above about 8.0% by weight, their chargeability is excessive, so that the charge quantity imparted to the toner particles cannot be easily controlled. Accordingly, a proper quantity of the silica must be selected based on these considerations.

The external additive in the toner composition according to an embodiment of the present invention may include a calcium-based titanium oxide. The quantity of the calcium-based titanium oxide may be about 0.1% by weight to about 3.0% by weight, based on 100% by weight of the toner particles.

The titanium oxide is present in the form having various acid values in addition to TiO₂; however, the TiO₂ form is the most common. TiO₂ is dissolved with an alkali to form an alkali titanium oxide. The external additive according to an embodiment of the present invention uses a calcium-based titanium oxide. The titanium oxide is used as a white pigment (titanium white) in large amounts, and it is usually used as a magnetic material, an abrasive, a medical product, a cosmetics, or the like.

The titanium oxide in the external additive according to an embodiment of the present invention functions to control excessive chargeability that occurs when the external additive only contains silica. The calcium-based titanium oxide used in an embodiment of the present invention may comprise primary particles having a size within a range of about 500 nm to about 1000 nm. The particle size of the titanium oxide may be determined with respect to the size of the toner particles and the compatibility with the toner in the same manner as determined with respect to the silica.

The external additive according to an embodiment of the present invention may comprise a cerium oxide. The cerium oxide is comprised in the external additive in the amount of about 0.1% by weight to about 4.0% by weight, based on 100% by weight of the toner particles. The primary particle size of the cerium oxide may be also determined with respect to the size of the toner particles and the compatibility with the toner, and in an embodiment of the present invention, the primary particle size may be within a range of about 1000 nm to about 1500 nm.

Cerium oxide is usually used as a friction material, and cerium oxide in the external additive according to an embodiment of the present invention functions as a cleaning agent for cleaning the toner particles remaining on a photoconductor, as a charge quantity control agent for controlling a charge quantity charged on the toner particles, and a filming preventer for preventing filming phenomenon occurring on a developing roller or a photoconductor.

The external additive according to an embodiment of the present invention is characterized by comprising all the above-mentioned silica, a calcium-based titanium oxide and a cerium oxide in the above-mentioned specific ratio, and is not very effective without all the components.

In addition to the foregoing, the toner composition according to an embodiment of the present invention may further comprise various additives for improving functionality. For example, a UV stabilizer, a mildewcide, a bactericide, a fungicide, an anti-static agent, a gloss modifier, an anti-oxidant, an anti-coagulant such as a silane or a silicon-modified silica particle, or the like, may be added to the toner composition as an internal additive or as an external additive.

Hereinafter, the example according to the present invention and the comparative example will be described.

### EXAMPLES

### Example 1

Preparation of Toner Particles (Pulverizing-Type Negative Polarity Toner)

| | |
|---|---|
| Polyester | about 90.5% by weight |
| Carbon black | about 5% by weight |
| Charge control agent (iron complex, the product | about 2.5% by weight |
| of HODOKAYA COMPANY) | |
| Low molecular weight polypropylene wax | about 2% by weight |

The above components were premixed uniformly by using the HENSCHEL type mixer, and then the melted mixture was extruded at 130° C. by putting in a twin-screw extruder and allowing to coagulate with cooling. Then, untreated toner particles before the operation of external addition, having an average particle diameter of about 8 μm, were obtained by using a pulverizing classifier.

Preparation of a Toner Composition

A toner composition was prepared by using the untreated toner particles and by adding externally an external additive having following components:

Negative-charged silica (primary particle size of about 5 nm to about 20 nm); about 1.0% by weight

Negative-charged silica (primary particle size of about 30 nm to about 200 nm); about 1.2% by weight

Calcium-based titanium oxide (primary particle size of about 500 nm to about 1000 nm); about 1.0% by weight

Cerium oxide (primary particle size of about 1000 nm to about 1500 nm); about 0.5% by weight.

### Comparative Example 1

Preparation of a Toner Composition

A toner composition was prepared by using the untreated toner particles prepared in the Example 1 and by adding externally an external additive having the following components:

Negative-charged silica (primary particle size of about 5 nm to about 20 nm); about 1.0% by weight

Negative-charged silica (primary particle size of about 30 nm to about 200 nm); about 1.2% by weight.

### Comparative Example 2

Preparation of a Toner Composition

A toner composition was prepared by using the untreated toner particles prepared in the Example 1 and by adding externally an external additive having following components:

Negative-charged silica (primary particle size of about 5 nm to about 20 nm); about 1.0% by weight

Negative-charged silica (primary particle size of about 30 nm to about 200 nm); about 1.2% by weight.

Calcium-based titanium oxide (primary particle size of about 500 nm to about 1000 nm); about 1.0% by weight.

### Comparative Example 3

Preparation of a Toner Composition

A toner composition was prepared by using the untreated toner particles prepared in the Example 1 and by adding externally an external additive having following components:

Negative-charged silica (primary particle size of about 5 nm to about 20 nm); about 1.0% by weight

Negative-charged silica (primary particle size of about 30 nm to about 200 nm); about 1.2% by weight.

Cerium oxide (primary particle size of about 1000 nm to about 1500 nm); about 0.5% by weight.

Tests

The toner compositions according to Example 1 and Comparative Examples 1 to 3 were developed under the developing conditions below and compared.

Developing Condition

Surface electric potential (V₀): about −700 V

Latent image electric potential (V_{L}): about −100 V

Voltage applied to the developing roller: V_{P-P}=about 1.8 KV, frequency=about 2.0 kHz,

V_{dc}=about −500V, duty ratio=about 35% (square wave)

Developing gap: about 150 μm to about 400 μm

Developing roller
(1) for aluminum
   roughness: Rz=about 1 to about 2.5 (after doping with nickel)
(2) for a rubber roller (nitrile butadiene-based elastic rubber roller)
   resistance: about 1×10⁵ Ω to about 5×10⁵ Ω
   hardness: about 50

Toner: Charged quantity (Q/M)=about −5 to about −30 μC/g (on a developing roller after passing a toner layer control apparatus)

Toner weight=about 0.3 mg/cm² to about 1.0 mg/cm²

Test Results

Images produced with the toner composition of Example 1, and Comparative Examples 1 to 3 under the above developing conditions were evaluated using a 20 ppm-grade LBP printer.

Image density, fog (background, a contamination in a non-image area), a feeding property and a filming phenomenon of a photoconductor for respective images were measured, and the performances of the respective toner compositions were compared. At this time, the image density was measured by measuring the density of a black solid pattern on paper, and the fog was measured by measuring the density at a non-image area on using the SPECTROEYE densitometer (manufactured by GRETAG MACBETH CO.). The feeding property and the filming phenomenon were evaluated with the naked eye.

Image Density

In the following Table 1, when the image density was above 1.3, it was evaluated as ∘, when the image density was 1.1 to 1.3, it was evaluated as Δ, and when the image density was less than 1.1, it was evaluated as x.

TABLE 1

Sheets

| | Initial | 1000 | 2000 | 3000 | 4000 | 5000 |
|---|---|---|---|---|---|---|
| Example 1 | ∘ | ∘ | ∘ | ∘ | ∘ | ∘ |
| Comp. | ∘ | ∘ | ∘ | ∘ | ∘ | ∘ |
| Example 1 | | | | | | |
| Comp. | ∘ | ∘ | ∘ | ∘ | ∘ | ∘ |
| Example 2 | | | | | | |
| Comp. | ∘ | ∘ | ∘ | ∘ | ∘ | ∘ |
| Example 3 | | | | | | |

As may be seen from Table 1, the image density was effective for both the toner composition, according to Example 1, and the toner composition that comprised only some components in the external additive. Accordingly, it may be seen that the image density may be maintained at a specific level for a somewhat long-term use if the external additive contains only a silica.

Fog

In the following Table 2, when the fog was less than 0.14, it was evaluated as ∘, when the fog was 1.15 to 1.16, it was evaluated as Δ, and when the fog was above 0.17, it was evaluated as x.

TABLE 2

Sheets

| | Initial | 1000 | 2000 | 3000 | 4000 | 5000 |
|---|---|---|---|---|---|---|
| Example 1 | ∘ | ∘ | ∘ | ∘ | ∘ | Δ |
| Comp. | ∘ | ∘ | Δ | Δ | x | x |
| Example 1 | | | | | | |
| Comp. | ∘ | ∘ | ∘ | Δ | x | x |
| Example 2 | | | | | | |
| Comp. | ∘ | ∘ | Δ | Δ | x | x |
| Example 3 | | | | | | |

As may be seen from Table 2, the toner composition of Example 1, comprising the external additive according to an embodiment of the present invention could produce clear images since the fog phenomenon was suppressed until some degree of sheets were printed. Meanwhile, the toner composition of COMPARATIVE EXAMPLE 1, comprising only silica, and the toner composition of COMPARATIVE EXAMPLE 3, comprising a silica and a cerium oxide, could not produce clear images due to the fogs from 2,000 sheets, and the toner composition of COMPARATIVE EXAMPLE 2, comprising a silica and a calcium-based titanium oxide, could not produce clear images due to the fogs from 3,000 sheets. Accordingly, it may be seen that the toner composition according to Example 1, which included a silica, a calcium-based titanium oxide and a cerium oxide, may maintain clear images for a long-term use.

Feeding Property

In the following Table 3, when the feeding property was very effective, it was evaluated as ∘, when the property was medium, it was evaluated as Δ, and when the property was ineffective, it was evaluated as x.

TABLE 3

Sheets

| | Initial | 1000 | 2000 | 3000 | 4000 | 5000 |
|---|---|---|---|---|---|---|
| Example 1 | ∘ | ∘ | ∘ | ∘ | Δ | Δ |
| Comp. | ∘ | ∘ | ∘ | Δ | Δ | x |
| Example 1 | | | | | | |
| Comp. | ∘ | ∘ | ∘ | ∘ | Δ | x |
| Example 2 | | | | | | |
| Comp. | ∘ | ∘ | ∘ | Δ | x | x |
| Example 3 | | | | | | |

As maybe seen from Table 3, the toner composition of Example 1 that included all of a silica, a calcium-based titanium oxide and a cerium oxide according to an embodiment of the present invention maintained a most extended feeding property.

Filming Phenomenon

In the following Table 4, when the filming phenomenon was ineffective, it was evaluated as ∘, when the phenomenon was tolerable, it was evaluated as Δ, and when the phenomenon occurred effectively, it was evaluated as x.

TABLE 4

Sheets

| | Initial | 1000 | 2000 | 3000 | 4000 | 5000 |
|---|---|---|---|---|---|---|
| Example 1 | ∘ | ∘ | ∘ | ∘ | ∘ | Δ |
| Comp. | ∘ | ∘ | Δ | x | x | x |
| Example 1 | | | | | | |
| Comp. | ∘ | ∘ | Δ | x | x | x |
| Example 2 | | | | | | |
| Comp. | ∘ | ∘ | ∘ | Δ | Δ | x |
| Example 3 | | | | | | |

As may be seen from Table 4, for the toner composition of Example 1, that includes all of a silica, a calcium-based titanium oxide and a cerium oxide according to embodiment of the present invention, the filming phenomenon does not occur over a comparatively long-term use.

According to the present invention explained above, by adding an external additive containing a micro particle silica, a macro particle silica, a calcium-based titanium oxide and a cerium oxide in a specific ratio to a toner composition, wherein the external additive is added to the toner composition to maintain an image density stably, the fog phenomenon does not occur, a feeding property is very effective, and the filming phenomenon does not occur.

The foregoing embodiment and advantages are merely exemplary and are not to be construed as limiting the present invention. The present teaching may be readily applied to other types of toner compositions. Also, the description of the embodiments of the present invention is intended to be illustrative, and not to limit the scope of the claims, and many alternatives, modifications, and variations will be apparent to those skilled in the art. Hence, it would be appreciated by those skilled in the art that changes may be made in these embodiments without departing from the principles and spirit of the invention, the scope of which is defined in the claims and their equivalents.

What is claimed is:

1. A toner composition comprising toner particles that include a coloring agent, a binder, a charge control agent, a release agent, and an external additive, wherein the external additive contains a silica, a calcium-based titanium oxide and a cerium oxide.

2. The toner composition as claimed in claim 1, wherein the quantity of the silica is about 0.1% by weight to about 8.0% by weight based on 100% by weight of the toner particles, the quantity of the calcium-based titanium oxide is about 0.1% by weight to about 3.0% by weight based on 100% by weight of the toner particles, and the quantity of the cerium oxide is about 0.1% by weight to about 4.0% by weight based on 100% by weight of the toner particles.

3. The toner composition as claimed in claim 2, wherein the silica includes micro particle silica and macro particle silica, and if the silica comprises a micro particle silica having a primary particle within a range of about 5 nm to about 20 nm, the amount of which is about 0.1% by weight to about 4.0% by weight based on 100% by weight of the toner particles, and a macro particle silica having a primary particle within a range of about 30 nm to about 200 nm, the amount of which is about 0.1% by weight to about 4.0% by weight based on 100% by weight of the toner particles.

4. The toner composition as claimed in claim 1, wherein the calcium-based titanium oxide comprises a primary particle within a range of about 500 nm to about 1000 nm.

5. The toner composition as claimed in claim 2, wherein the calcium-based titanium oxide comprises a primary particle within a range of about 500 nm to about 1000 nm.

6. The toner composition as claimed in claim 1, wherein the cerium oxide comprises a primary particle within a range of about 1000 nm to about 1500 nm.

7. The toner composition as claimed in claim 2, wherein the cerium oxide comprises a primary particle within a range of about 1000 nm to about 1500 nm.

8. The toner composition as claimed in claim 1, wherein the silica is negatively-charged.

9. The toner composition as claimed in claim 2, wherein the silica is negatively-charged.

10. The toner composition as claimed in claim 1, wherein a quantity of the coloring agent in the toner composition is within a range of 1% by weight to 10% by weight, based on 100% by weight of toner particles.

11. The toner composition as claimed in claim 10, wherein the coloring agent is one of a dye-based coloring agent or a pigment-based coloring agent.

12. The toner composition as claimed in claim 11, wherein the coloring agent is a pigment-based coloring agent and is selected from the group consisting of an organic color pigment, including an azo-based pigment, a phthalocyanin-based pigment, a basic dye-based pigment, a quinactridone-based pigment, a dioxazine-based pigment and a condensation azo-based pigment; an inorganic color pigment, including chromates, ferrocyanides, oxides, sulfate selenides, sulfates, silicates, carbonates, phosphates and metal powders; and an inorganic black pigment including carbon black.

13. The toner composition as claimed in claim 1, wherein the binder is a binder resin, and a quantity of the binder resin is within a range of 80% to 98% by weight, based on 100% by weight of the total toner particles.

14. The toner composition as claimed in claim 13, wherein the binder resin is selected from the group consisting of a homopolymer of a styrene including a polystyrene and a polyvinyltoluene, and its derivative, a styrene copolymer including a styrene-acrylic copolymer, a polyethylene, a polypropylene, a vinyl chloride-based resin, a polyacrylate, a polymethacrylate, a polyester, a polyacrylonitrile, a melamine resin, an epoxy resin, and a combination thereof.

15. The toner composition as claimed in claim 1, wherein a quantity of the charge control agent is within a range of about 0.1% by weight to about 10% by weight, based on 100% by weight of the total toner particles.

16. The toner composition as claimed in claim 15, wherein the charge control agent is one of a positive charge control agent or a negative charge control agent, the negative charge control agent is selected from the group consisting of an azo-based pigment including chrome, a salicylic acid compound containing metal including chrome, iron, or zinc, alone or in combination, and the positive charge control agent is selected from the group consisting of a nigrocine, a quaternary ammonium salt, and a triphenylmethane derivative, alone or in combination.

17. The toner composition as claimed in claim 1, wherein the releasing agent is a wax, and a content of the wax is within a range of about 1% by weight to about 10% by weight, based on 100% by weight of total toner particles.

18. The toner composition as claimed in claim 17, wherein the wax is selected from the group consisting of a natural plant wax, including a carnauba wax and a bay-berry wax; a natural animal wax, including a bees wax, a shellac wax and a spermacetti wax; a mineral wax, including a montanic wax, an ozokerite wax and a ceresin wax; a petroleum wax, including a paraffin wax and a microcrystalline wax; and a synthetic wax, including a polyethylene wax, a polypropylene wax, an acrylate wax, a fatty acid amide wax, a silicon wax, a polytetrafluoroethylene wax, any of said waxes being selected alone or in combination.

19. The toner composition as claimed in claim 1, wherein the external additive includes a calcium-based titanium oxide that is about 0.1% by weight to about 3.0% by weight, based on 100% by weight of the toner particles.

20. The toner composition as claimed in claim 1, wherein the external additive includes cerium oxide that is about 0.1% by weight to about 4.0% by weight, based on 100% by weight of the toner particles.
